(19) United States
(12) Patent Application Publication
(10) Pub. No.: US 2015/0019711 A1
(43) Pub. Date: Jan. 15, 2015

(54) SERVER SYSTEM AND A DATA TRANSFERRING METHOD THEREOF

(71) Applicants: INVENTEC CORPORATION, Taipei City (TW); Inventec (Pudong) Technology Corporation, Shanghai (CN)

(72) Inventor: Li ZHANG, Shanghai (CN)

(73) Assignees: INVENTEC CORPORATION, Taipei City (TW); Inventec (Pudong) Technology Corporation, Shanghai (CN)

(21) Appl. No.: 14/018,414

(22) Filed: Sep. 4, 2013

(30) Foreign Application Priority Data
Jul. 10, 2013 (CN) 201310288805.6

(51) Int. Cl. H04L 12/26

(52) U.S. Cl. CPC H04L 43/0876
USPC 709/224

(57) ABSTRACT

A server system includes a plurality of server nodes and a management module. Each server node includes a node control module that gathers operation state information of a corresponding server node. The node control module communicates with the management module through an uplink data channel. The operation state information of the corresponding server node is packaged into a data packet by each node control module. The data packet is automatically transferred to the management module by the node control module through the uplink data channel according to a default value. When the management module receives the data packet, the management module analyzes the data packet so as to control operation of the server node according to the operation state information of the server node.

### RELATED APPLICATIONS

This application claims priority to Chinese Application Serial Number 201310288805.6, filed Jul. 10, 2013, which is herein incorporated by reference.

### BACKGROUND

1. Field of Invention

The invention relates to a server system, and particularly relates to a server system which can improve bandwidth efficiency and a data transferring method thereof.

2. Description of Related Art

In recent years, with rapid development of science and technology, the function of the computer system is becoming more and more powerful. order to enable effective monitor of operation conditions of various components on a motherboard, many motherboard manufacturers use a baseboard management controller (BMC) to monitor various operations of the system and transfer a monitoring result to a management module.

Generally, the BMC periodically polls various sensors on the motherboard to monitor the current work state of hardware on the motherboard, and according to a request message sent by the management module to the BMC, transfers the monitoring result to the management module for further process. In other words, under this transfer mode when the management module sends a request message, at the same time the BMC does not transfer the monitoring result to the management module; and vice verse, when the BMC transfers the monitoring result to the management module, at the same time the management module does not send the request message. Therefore such a transfer manner is unfavorable to the bandwidth efficiency, and there are still spaces for further improvement.

### SUMMARY

In view of the aforesaid poor bandwidth efficiency, the invention solves the bandwidth occupation problem by automatically transferring a monitoring result to the management module according to a default value.

An aspect of the invention provides a server system. The server system includes a plurality of server nodes and at least one management module. Each server node includes a node control module that gathers operation state information of a corresponding server node. Each node control module communicates with the management module through an uplink data channel. The operation state information of the corresponding server node is packaged into a data packet by each node control module. The data packet is automatically transferred to the management module by the node control module through the uplink data channel according to a default value. When the management module receives the data packet, the management module analyzes the data packet so as to control operation of the server node according to the operation state information of the server node.

In an embodiment, the default value is a fixed time period, wherein every time after this fixed time period each node control module transfers the data packet through the uplink data channel to the management module.

In another embodiment, the default value is an information change, wherein when the operation state information of one of the server nodes changes, the node control module corresponding to the server node transfers the data packet through the uplink data channel to the at least one management module.

In an embodiment, the management module further includes an error-correcting module, such that when an information transfer error occurs to one of the server nodes, the server node can be detected by the error-correcting module. The error-correcting module determines whether the information transfer error occurs by detecting whether a node control module corresponding to the one of the server node stops the information transfer action.

In an embodiment, downlink data channel is further included. The management module transfers a command to the server nodes through the downlink data channel. The command is a switch command.

In an embodiment, the operation state information of the corresponding server node can be classified and packaged into a plurality of data packets by the node control module, and a system management controller is coupled to the management module. The plurality of received data packets is packaged again by the management module and transferred to the system management controller. The operation state information is temperature information.

In an embodiment, the system management controller may be a racks management controller (RMC), the management module may be a fan controller board (FCB), and the node control module may be a baseboard management controller (BMC), wherein the FCB is further electrically connected to a fan module used for dissipating heat of the server nodes and adjusts a rotational speed of each fan in the fan module according to the temperature information.

In an embodiment, the management module is a RMC and the node control module is a BMC, wherein each server node is further connected to a fan, and the BMC controls the rotational speed of the fan according to the temperature information.

Another aspect of the invention provides a server system data transferring method. The server system at least includes a plurality of server nodes and at least one management module. First, the operation state information of the server nodes is gathered and packaged into a plurality of data packets. Subsequently, the data packets are automatically transferred to the management module through an uplink data channel according to a default value. At last, the data packets are received and then analyzed, wherein the management module manages the operation of the server nodes according to the operation state information of the server nodes.

In view of the above, in the invention the operation state information of a corresponding server is actively transferred to the management module by the node control module according to a default value, without the need of transferring a request message to the node control module by the management module therebefore. Therefore, the bandwidth used for transferring the request message will not be occupied and the use of bandwidth becomes more effective.

### BRIEF DESCRIPTION OF THE DRAWINGS

FIG. 1 illustrates a schematic view of a server system according to an embodiment of the invention:

FIG. 2 illustrates a schematic view of a server system according to another embodiment of the invention;

FIG. 3 illustrates a schematic view of a server system according to a further embodiment of the invention; and

FIG. 4 illustrates a flow chart of a data transferring method of a server system according to an embodiment of the invention.

### DETAILED DESCRIPTION

Specific embodiments of the invention are described in details as follows with reference to the accompanying drawings, wherein throughout the following description and drawings, the same reference numerals refer to the same or similar elements and are omitted when the same or similar elements are stated repeatedly.

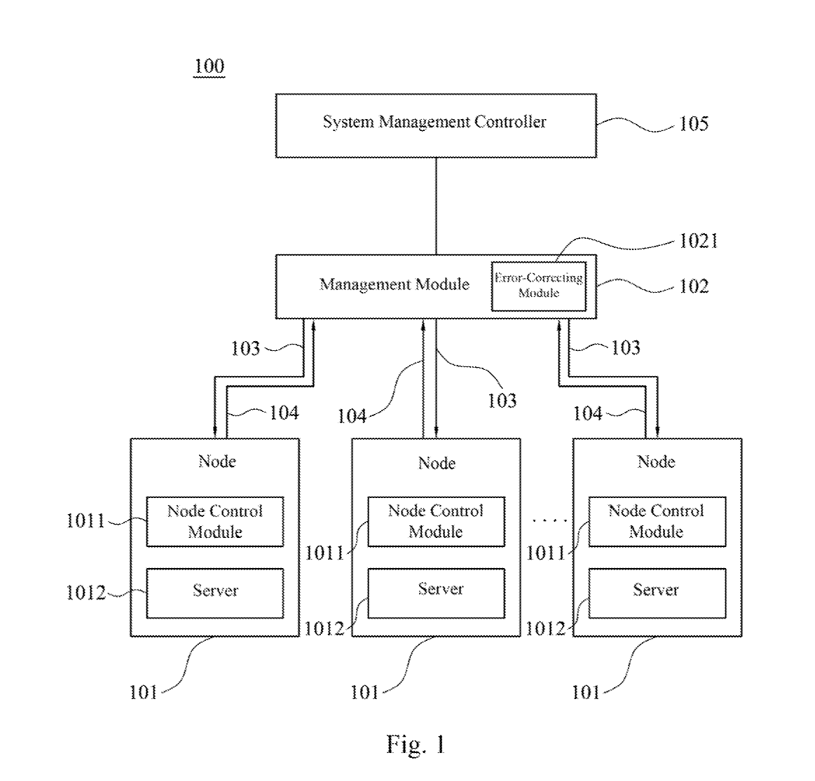

FIG. 1 illustrates a schematic view of a server system according to an embodiment of the invention. A server system 100 of the invention includes a plurality of server nodes 101 and at least one management module 102. Each server node 101 includes a node control module 1011 and a corresponding server 1012, wherein the node control module 1011 can gather operation state information of the corresponding server 1012 (i.e., a node). Furthermore, the node control modules 1011 are respectively connected to one of the management modules 102 through an uplink data channel 103, so as to transfer the operation state information of the corresponding server 1012 to the management module 102. Conventionally, first the management module 102 transfers a request message to the node control module 1011, and then the node control module 1011 transfers the operation state information of the corresponding server 1012 to the management module 102. However, such a transfer manner is unfavorable to the bandwidth efficiency. Thus, in the invention the node control module 1011 transfers the operation state information of the corresponding server 1012 to the management module 102 according to a default value. That is, as long as the default value is achieved, the node control module 1011 can automatically transfers the operation state information of the corresponding server 1012 to the management module 102, without the need of transferring a request message to the node control module 1011 by the management module 102 therebefore, such that the bandwidth will not be occupied and the use of bandwidth becomes more effective.

The node control module 1011 periodically polls various sensors (not depicted in the figures) on the corresponding server 1012 to monitor the current operation state of the server 1012 and classify and package the operation state information of the corresponding server 1012 into a plurality of data packets. When the default value is achieved, the node control module 1011 actively transfers the data packet to the management module 102 through the uplink data channel 103. After receiving the data packets transferred by the node control module 1011, the management module 102 analyzes the data packets and controls operation of various servers 1012 according to the operation state information stored in the data packets. In an embodiment the default value is a fixed time period. That is, every time after this fixed time period the node control module 1011 actively transfers the current operation state of the server 1012 to the management module 102 through the uplink data channel 103. another embodiment, the default value is an information change, such as a change of the operation state of the server 1012. That is, every time when the node control module 1011 detects a violent change occurred to the current operation state of the corresponding server 1012, such as disabled operation, the node control module 1011 actively transfers the current operation state of the server 1012 to the management module 102 through the uplink data channel 103. In actual operation, a threshold value may be set, and when the change rate of the operation state exceeds the threshold value, the node control module 1011 actively transfers the current operation state of the server 1012 to the management module 102. For example, the threshold value is set as 2° C., and when the node control module 1011 detects that the current temperature change rate of the corresponding server 1012 exceeds 2° C., the node control module 1011 actively transfers the current operation state of the server 1012 to the management module 102. Furthermore, the management module 102 of the invention further includes an error-correcting module 1021, wherein when an information transfer error occurs to one of the server nodes 101, the error-correcting module 1021 detects the server node. In an embodiment, the error-correcting module 1021 determines whether the information transfer error occurs by detecting whether each node control module 1011 corresponding to each server node 101 stops the information transfer action. The server system 100 further includes downlink data channel 104. The management module 102 can transfer commands to the server nodes through this downlink data channel 104, for example commanding the node control module 1011 to control turn on or off of the corresponding server 1012.

Moreover, the server system of the invention further includes a system management controller 105 which is coupled to the management module 102. If one server system has a plurality of management modules 102, the system management controller 105 may be coupled to the plurality of management modules 102 to perform integrated management and control of the entire server system. Each management module 102 packages the plurality of data packets which have been transferred, classified and packaged by the node control module 1011 for the second time to transfer to the system management controller 105. The system management controller 105 can determine one data packet is transferred by which management module 102 according to the type of the packaged data packet, so as to perform management of the entire server system. For example, in an embodiment a corresponding server 1012 includes a motherboard and a heat-dissipation fan, and the node control module 1011 periodically polls various sensors on the corresponding server 1012 to respectively monitor current operation states of the motherboard and the heat-dissipation fan and classify and package the operation state information of the motherboard and the heat-dissipation fan into data packets to be transferred to the management module 102. The management module 102 then packages the data packets for the motherboard and the data packets for the heat-dissipation fan for the second time to include information indicating the corresponding management module 102, so as to transfer to the system management controller 105. Subsequently the system management controller 105 can determine the operation state information is transferred by which management module 102 according to the twice-packaged information, so as to perform a corresponding management.

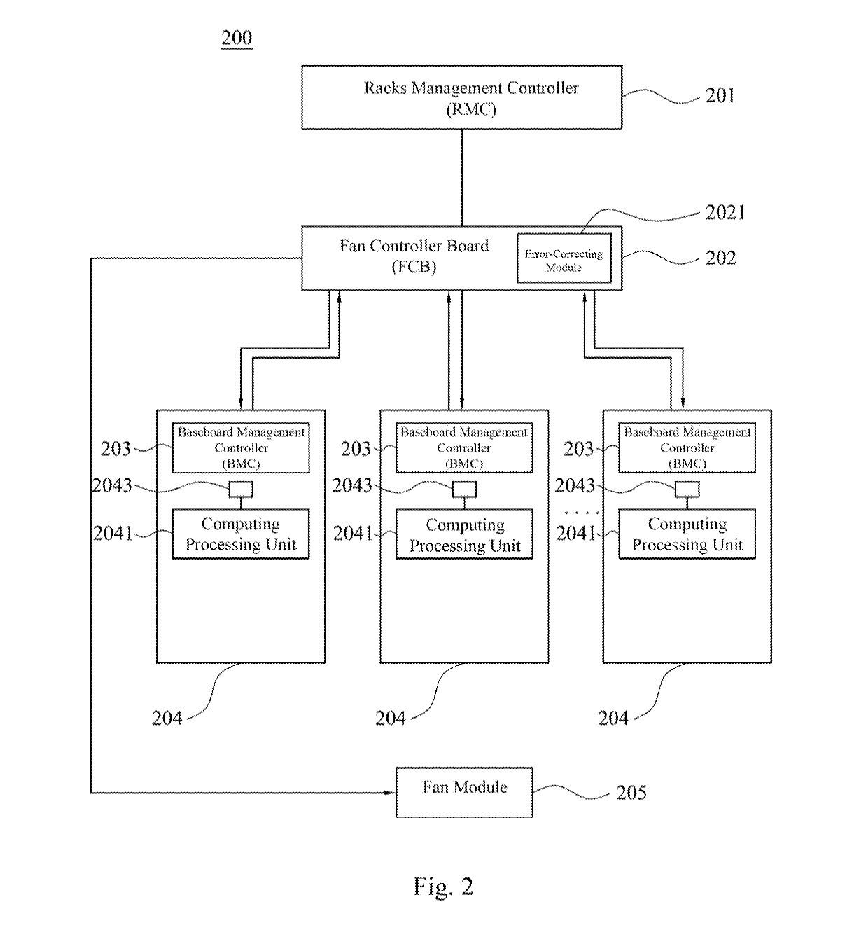

In an embodiment, the system management controller 105 shown in FIG. 1 for example is a racks management controller (RMC). The management module 102 for example is a fan controller board (FCB). The node control module 1011 for example is a baseboard management controller (BMC) arranged on the motherboard. FIG. 2 illustrates a schematic view of a server system according to this embodiment of the invention. The server system 200 includes a RMC 201, a FCB 202, a BMC 203 and a fan module 205 having a plurality of fans. The BMC 203 is arranged on a motherboard 204. The motherboard 204 includes for example a computing processing unit 2041 and a temperature sensor 2043 thereon. The FCB 202 is electrically connected to the fan module 205, and the fan module 205 is used for dissipating heat for the plurality of server nodes. The FCB 202 adjusts a rotation speed of a corresponding fan included in the fan module 205 according to information such as the temperature information stored on the computing processing unit 2041 of each motherboard, so as to control a working temperature of the corresponding computing processing unit 2041. It should be noted that in this embodiment only the configuration of the computing processing unit 2041 arranged on the motherboard 204 is used to illustrate the application of the invention, but the application and structure of the invention are not limited by the aforesaid embodiment. According to this embodiment, the BMC 203 repeatedly reads a measured working temperature value from h temperature sensor 2043 of each motherboard 204 in a polling manner, so as to obtain the working temperature value of the computing processing unit 2041 and package the measured working temperature value into a data packet.

When the default value is achieved, the BMC 203 actively transfers the data packet to the FCB 202. After receiving the data packet transferred by the BMC 203, the FCB 202 analyzes the data packet and controls the operation state of the fan module 205 according to the working temperature value of the computing processing unit 2041 stored in the data packet. In an embodiment, the default value is a fixed time period. That is, every time after this fixed time period the BMC 203 actively transfers the data packet obtained by packaging the working temperature value of the computing processing unit 2041 to the FCB 202 to control the operation state of the fan module 205. In another embodiment, the default value is an information change, such as a change of the operation state. That is, every time when the BMC 203 detects a violent change occurred to the operation state of the computing processing unit 2041 on a motherboard, which exceeds a threshold value (for example the temperature is increased sharply to exceed the predetermined threshold value), the BMC 203 actively transfers the unexpected state to the FCB 202 for immediate treatment. In an embodiment, the threshold value is set as 2° C., and when the BMC 203 detects that the current temperature change rate of the computing processing unit 2041 exceeds 2° C., the BMC 203 actively transfers the current operation state of the computing processing unit 2041 to the FCB 202 to perform a corresponding treatment, for example increasing the rotation speed of the fan module 205 to lower the temperature timely.

Additionally, the FCB 202 is further coupled to a RMC 201. The FCB 202 packages the working temperature value of the computing processing unit 2041 transferred by the BMC 203 for the second time to include information indicating the corresponding FCB 202, so as to transfer to the RMC 201. The RMC 201 can determine the data packet is transferred by which FCB 202 according to the type of the packaged data packet, so as to perform a corresponding management. Furthermore, the FCB 202 further includes an error-correcting module 2021, such that when an information transfer error occurs to one of the BMCs 203, the BMC 203 can be detected by the error-correcting module 2021. The error-correcting module 2021 determines whether the information transfer error occurs by detecting whether each BMC 203 stops the information transfer action.

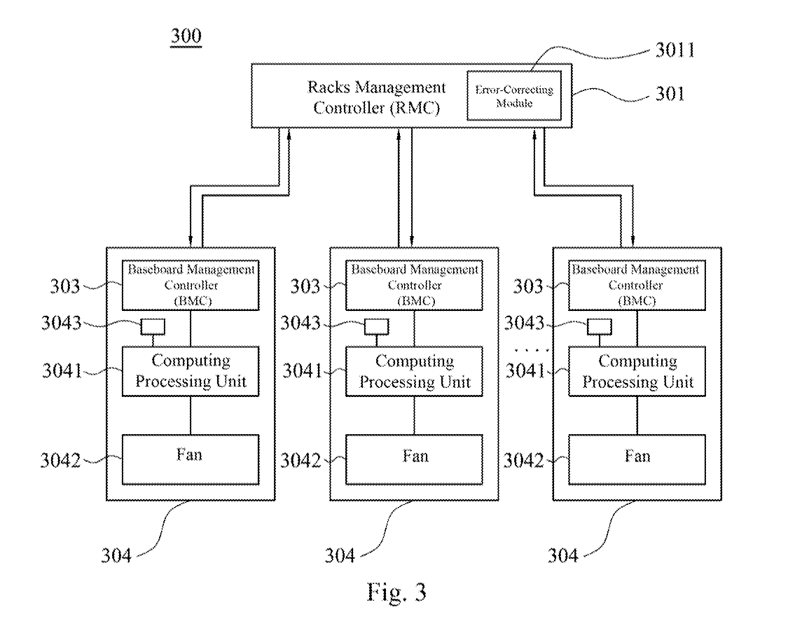

In another embodiment, the management module 102 shown in FIG. 1 for example is a racks management controller (RMC). The node control module 1011 for example is a baseboard management controller (BMC) arranged on the motherboard. FIG. 3 illustrates a schematic view of a server system according to this embodiment of the invention. A server system 300 includes a RMC 301 and a BMC 303. The BMC 303 is arranged on a motherboard 304. The motherboard 304 for example includes a computing processing unit 3041, a fan 3042 and a temperature sensor 3043 thereon. It should be noted that in this embodiment only the configuration of the computing processing unit 3041 arranged on the motherboard 304 and the fan 3042 are used to illustrate the application of the invention, but the application and structure of the invention are not limited by the aforesaid embodiment. According to this embodiment, the BMC 303 adjusts a rotation speed of a corresponding fan 3042 according to information such as the temperature information of the computing processing unit 3041 on each motherboard, so as to control the working temperature of the computing processing unit 3041. The BMC 303 repeatedly reads the measured working temperature value of the computing processing unit 3041 from the temperature sensor 3043 of each motherboard 304 in a polling manner and adjusts the rotation speed of the fan 3042 according to the temperature information. Additionally, when the default value is achieved, the BMC 303 actively transfers the data packet to the RMC 301 to perform subsequent treatments. In an embodiment, the default value is a fixed time period. That is, every time after this fixed time period the BMC 303 actively transfers the data packets obtained by classifying and packaging the working temperature value of the computing processing unit 3041 and the rotation state of the fan 3042 to the RMC 301 to perform subsequent control. Furthermore, the RMC 301 further includes an error-correcting module 3011, such that if an information transfer error occurs to one of the BMCs 303 when the BMCs 303 transfer the data packets to the RMC 301, the BMC 303 can be detected by the error-correcting module 3011. The error-correcting module 3011 determines whether the information transfer error occurs to the BMC 303 by detecting whether each BMC 303 stops the information transfer action.

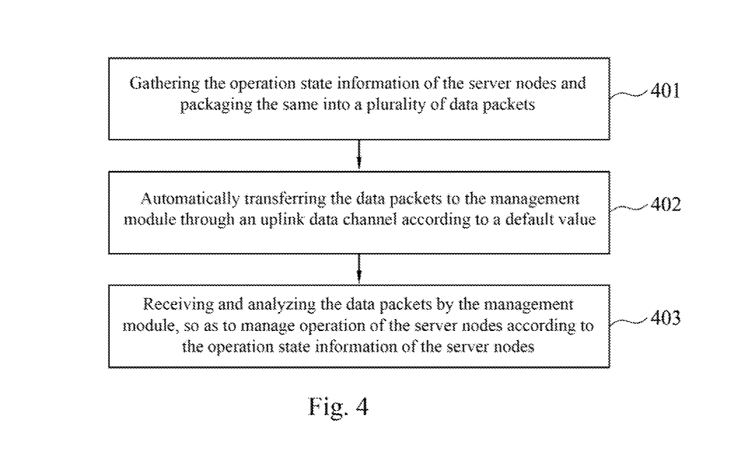

FIG. 4 illustrates a data transferring method of a server system according to an embodiment of the invention. References are made to both of FIG. 1 and FIG. 4. Firstly in step 401, the operation state information of the server nodes are gathered and packaged into a plurality of data packets. In an embodiment, the server system at least includes a plurality of server nodes and at least one management module. Each server node 101 further includes a node control module 1011 and a corresponding server 1012. The node control module 1011 can gather the operation state information of the corresponding server 1012 (i.e., a node) and package the same into a plurality of data packets. Subsequently in step 402, the data packets are automatically transferred to the management module through an uplink data channel according to a default value. In an embodiment, the node control module 1011 is coupled to the management module 102 through an uplink data channel 103 and transfers a plurality of data packets to the management module 102 according to a default value, wherein the default value is for example a fixed time period or a change of operation state information. That is, every time after this fixed time period or the change of operation state information, the node control module 1011 actively transfers the current operation state of the server 1012 to the management module 102 through the uplink data channel 103. At last in step 403, when receiving the data packet, the management module analyzes the data packet, so as to manage operation of the server nodes according to the operation state information of the server nodes.

In view of the above, in the invention the operation state information of a corresponding server is actively transferred to the management module by the node control module according to a default value, without the need of transferring a request message to the node control module by and the management module therebefore, such that the bandwidth used for transferring the request message will not be occupied and the bandwidth is only occupied when the server operation state information is transferred to the management module. Therefore, the use of bandwidth becomes more effective.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. A server system, at least comprising:
a plurality of server nodes each comprising a node control module, wherein the node control module can gather an operation state information of a corresponding server node; and
at least one management module, wherein each of the node control modules communicates with the at least one management module through an uplink data channel;
wherein each of the node control modules packages the operation state information of the corresponding server node into a data packet and then automatically transfers the data packet to the management module through the uplink data channel according to a default value,
when receiving the data packet, the at least one management module analyzes the data packet and manages operation of the server node according to the operation state information of the corresponding server node.

2. The server system of claim 1, wherein the default value is a fixed time period, wherein every time after the fixed time period, each of the node control modules transfers the data packet to the at least one management module through the uplink data channel.

3. The server system of claim 1, wherein the default value is an information change, wherein when the operation state information of one of the server nodes changes, the node control module corresponding to the server node transfers the data packet to the at least one management module through the uplink data channel.

4. The server system of claim 1, wherein the management module further comprises an error-correcting module, such that when an information transfer error occurs to one of the server nodes, the server node is detected by the error-correcting module.

5. The server system of claim 4, wherein the error-correcting module determines whether an information transfer error occurs by detecting whether the node control module corresponding to one of the server nodes stops the information transfer action.

6. The server system of claim 1, further comprising a downlink data channel, wherein the management module transfers a command to the server nodes through the downlink data channel.

7. The server system of claim 6, wherein the command is a switch command.

8. The server system of claim 1, wherein each of the node control modules classifies and packages the operation state information of the corresponding server nodes into a plurality of data packets.

9. The server system of claim 8, wherein a system management controller is further coupled to the at least one management module, and the at least one management module packages the received plurality of data packets for a second time to transfer to the system management controller.

10. The server system of claim 9, wherein the system management controller is a racks management controller (RMC), the management module is a fan controller board (FCB), and the node control module is a baseboard management controller (BMC).

11. The server system of claim 10, wherein the operation stage information is temperature information.

12. The server system of claim 11, wherein the at least one fan controller board (FCB) is further electrically connected to a fan module used for dissipating heat for the plurality of server nodes and adjusts the rotation speed of each fan in the fan module according to the temperature information.

13. The server system of claim 1, wherein the management module is a racks management controller (RMC), and the node control module is a baseboard management controller (BMC).

14. The server system of claim 13, wherein the operation state information is temperature information.

15. The server system of claim 14, wherein each server node is further connected to a fan, and the baseboard management controller (BMC) controls the rotation speed of the fans according to the temperature information.

16. A data transferring method of a server system, wherein the server system comprises a plurality of server nodes and at least one management module, wherein the method comprises:
gathering the operation state information of the server nodes and packaging the operation state information into a plurality of data packets;
automatically transferring the data packets to the at least one management module through an uplink data channel according to a default value; and
receiving and analyzing the data packets, wherein the at least one management module manages operation of the server nodes according to the operation state information of the server nodes.

17. The data transferring method of the server system of claim 16, wherein the default value is a fixed time period, wherein every time after the fixed time period, the data packets are automatically transferred to the at least one management module through the uplink data channel according to the fixed time period.

18. The data transferring method of the server system of claim 16, wherein the default value is an information change, wherein when the operation state information of one of the server nodes changes, the corresponding data packet is automatically transferred to the at least one management module through the uplink data channel.

19. The data transferring method of the server system of claim 16, further comprising: correcting errors occurred to the server nodes, such that when the information transfer error occurs to one of the server nodes, the server node is detected.

20. The data transferring method of the server system of claim 19, further comprising: detecting whether one of the server nodes stop information transfer action, so as to determine whether an information transfer error occurs.

21. The data transferring method of the server system of claim 16, further comprising: transferring a command to the server nodes by the at least one management module through a downlink data channel.

22. The data transferring method of the server system of claim 21, wherein the command is a switch command.

23. The data transferring method of the server system of claim 16, further comprising: classifying and packaging the operation state information of the server nodes into a plurality of data packets.

24. The data transferring method of the server system of claim 23, further comprising: packaging the plurality of data packets for a second time to transfer to a system management controller.
